(19) United States
(12) Patent Application Publication
(10) Pub. No.: US 2026/0112823 A1
(43) Pub. Date: Apr. 23, 2026

(54) ELECTRIC WIRE WITH TERMINAL AND MANUFACTURING METHOD OF ELECTRIC WIRE WITH TERMINAL

(71) Applicant: YAZAKI CORPORATION, Tokyo (JP)

(72) Inventor: Masahiro DENO, Shizuoka (JP)

(73) Assignee: YAZAKI CORPORATION, Tokyo (JP)

(21) Appl. No.: 19/361,829

(22) Filed: Oct. 17, 2025

(30) Foreign Application Priority Data
Oct. 23, 2024 (KR) 2024-186936

(51) Int. Cl. H01R 4/18; H01R 4/20; H01R 11/28; H01R 43/048

(52) U.S. Cl. CPC H01R 4/183; H01R 4/188; H01R 4/20; H01R 11/28; H01R 43/048

(57) ABSTRACT

A terminal-equipped electric wire includes a terminal, an electric wire connected to the terminal, and a tubular component covering an electrical contact between the terminal and the electric wire. The terminal includes a rod-shaped contact portion, the electric wire includes a conductor core wire electrically connected to the contact portion, and the tubular component is disposed such that the conductor core wire is sandwiched between an outer peripheral surface of the contact portion and an inner tubular surface of the tubular component, and the tubular component presses the conductor core wire toward the outer peripheral surface of the contact portion to crimp the contact portion and the conductor core wire. The terminal includes an engagement portion having an uneven shape on the outer peripheral surface of the contact portion. The conductor core wire of the electric wire is pressed by the tubular component to engage with the engagement portion.

### CROSS-REFERENCE TO RELATED APPLICATIONS

This application is based on and claims priority under 35 USC 119 from Japanese Patent Application No. 2024-186936 filed on Oct. 23, 2024, the contents of which are incorporated herein by reference.

### TECHNICAL FIELD

The present invention relates to a terminal-equipped electric wire in which a terminal and an electric wire are electrically connected, and a method for manufacturing the terminal-equipped electric wire.

### BACKGROUND ART

The related art has proposed to manufacture a terminal-equipped electric wire by using a terminal including: a connection portion to be connected to a mating terminal; and a crimping portion having a tubular shape continuous without a slit in a circumferential direction (so-called closed barrel shape), and to be crimped to a conductor core wire of an electric wire (see, for example, Patent Literature 1).

### CITATION LIST

### Patent Literature

Patent Literature 1: JP2017-224396A

### SUMMARY OF INVENTION

### Technical Problem

In the above type of terminal-equipped electric wire, generally, the conductor core wire of the electric wire is inserted into the tube of the crimping portion of the terminal, and then the crimping portion is crimped so as to be crushed toward the tube using a mold for crimping to crimp the crimping portion and the conductor core wire, thereby electrically connecting the terminal and the electric wire. Due to such a structure, in this type of terminal-equipped electric wire, the thickness of the crimping portion of the terminal and the size of the inner diameter of the tube of the crimping portion are changed according to the size of the thickness of the electric wire (in other words, the bundle diameter of the conductor core wire to be inserted into the tube of the crimping portion). That is, when producing the terminal-equipped electric wire, a dedicated terminal corresponding to a required specification such as a thickness of the electric wire is used. Therefore, the terminal cannot be shared, and it is difficult to reduce the production cost of the terminal-equipped electric wire.

An object of the present invention is to provide a terminal-equipped electric wire capable of coping with a plurality of specifications while sharing a terminal, and a method for manufacturing the terminal-equipped electric wire.

### SOLUTION TO PROBLEM

In order to achieve the object described above, a terminal-equipped electric wire according to the present invention and a method for manufacturing the terminal-equipped electric wire are characterized as follows.

A terminal-equipped electric wire includes a terminal, an electric wire connected to the terminal, and a tubular component covering an electrical contact between the terminal and the electric wire. The terminal includes a rod-shaped contact portion, the electric wire includes a conductor core wire electrically connected to the contact portion, and the tubular component is disposed such that the conductor core wire is sandwiched between an outer peripheral surface of the contact portion and an inner tubular surface of the tubular component, and the tubular component presses the conductor core wire toward the outer peripheral surface of the contact portion to crimp the contact portion and the conductor core wire.

A method for manufacturing a terminal-equipped electric wire in which a terminal and an electric wire are electrically connected, the method includes a step of disposing a conductor core wire of the electric wire so as to cover an outer peripheral surface of a rod-shaped contact portion of the terminal; a step of preparing a tubular component having an inner tubular surface with an inner diameter allowing the conductor core wire to be sandwiched between the inner tubular surface and the outer peripheral surface of the contact portion, and disposing the tubular component so as to sandwich the conductor core wire between the inner tubular inner surface and the outer peripheral surface; and a step of crimping the contact portion and the conductor core wire by integrally crimping the tubular component, the conductor core wire, and the contact portion using a crimping tool configured to deform the tubular component so as to reduce a diameter of the tubular component.

According to the terminal-equipped electric wire according to the present invention and the method for manufacturing the terminal-equipped electric wire, the tubular component is disposed such that the conductor core wire of the electric wire is sandwiched between the outer peripheral surface of the rod-shaped contact portion of the terminal and the inner tubular surface of the tubular component, and the tubular component presses the conductor core wire to crimp the conductor core wire and the contact portion. That is, in the terminal-equipped electric wire having this configuration, unlike the related terminal-equipped electric wire, the terminal and the electric wire are electrically connected without inserting the conductor core wire into the contact portion of the terminal. Therefore, even when the thickness of the electric wire or the bundle diameter of the conductor core wire is different for each required specification, a common terminal can be used. When a tubular component having an inner diameter corresponding to the thickness or the like of the electric wire is used, the terminal-equipped electric wire can be manufactured. In general, a terminal manufactured to correspond to the structure of the mating terminal or the connector housing is higher in production cost than a simple tubular component. Therefore, even if a plurality of types of tubular components having different inner diameters are used, the overall production cost can be reduced by sharing the terminal. As described above, the terminal-equipped electric wire according to the present invention and the method for manufacturing the terminal-equipped electric wire can cope with a plurality of specifications while sharing the terminal.

The present invention is briefly described above. Further, details of the present invention will be clarified by reading modes for carrying out the invention described below with reference to the accompanying drawings.

### BRIEF DESCRIPTION OF DRAWINGS

FIG. 1 is a perspective view illustrating a terminal-equipped electric wire according to an embodiment of the present invention.

FIG. 2 is a side view illustrating a first step of manufacturing the terminal-equipped electric wire illustrated in FIG. 1.

FIG. 3 is an enlarged view of a portion A in FIG. 2.

FIG. 4 is a side view illustrating a second step of manufacturing the terminal-equipped electric wire illustrated in FIG. 1.

FIG. 5 is a side view illustrating a third step of manufacturing the terminal-equipped electric wire illustrated in FIG. 1.

FIG. 6 is a side view illustrating a fourth step of manufacturing the terminal-equipped electric wire illustrated in FIG. 1.

FIG. 7 is a cross-sectional view taken along a line B-B in FIG. 6.

FIG. 8 is an enlarged view of a portion C in FIG. 7.

### DESCRIPTION OF EMBODIMENTS

### Embodiments

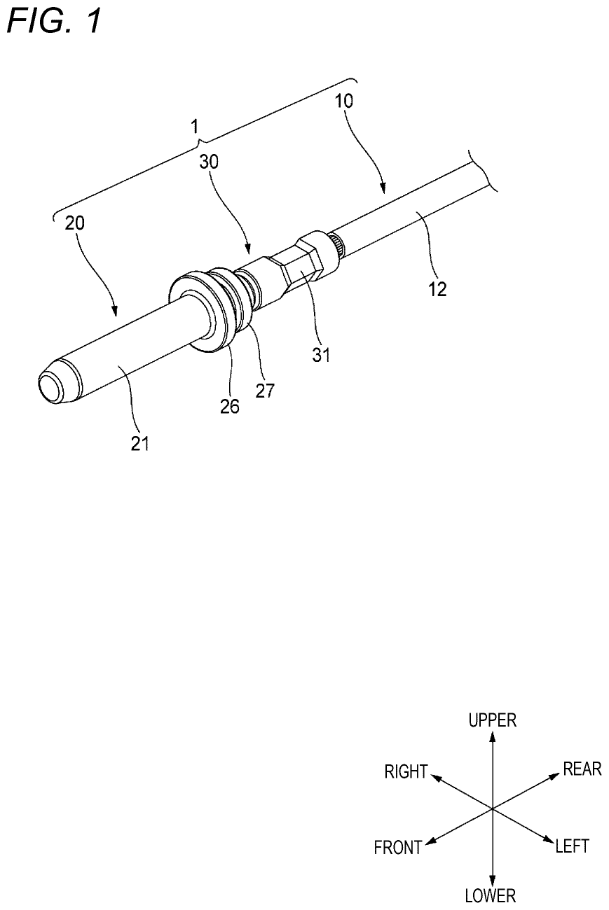

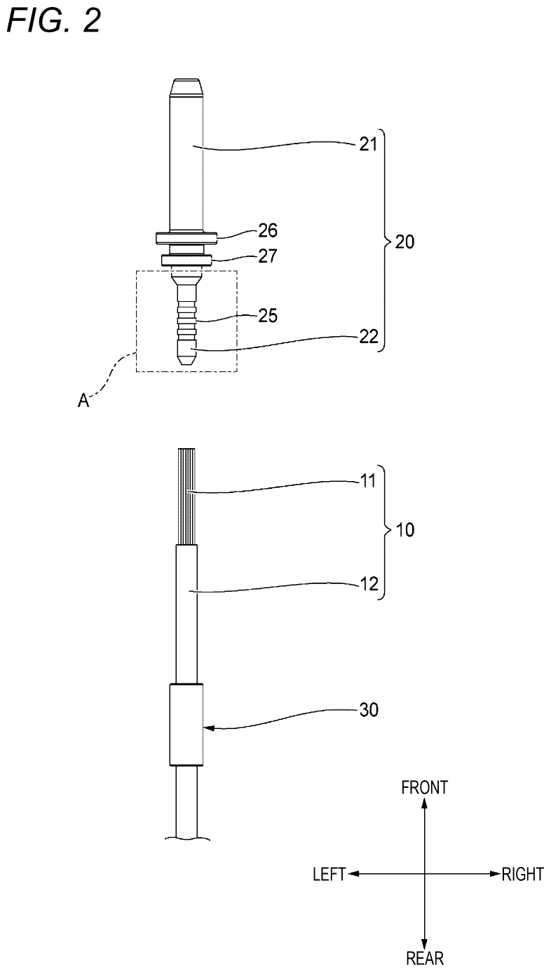

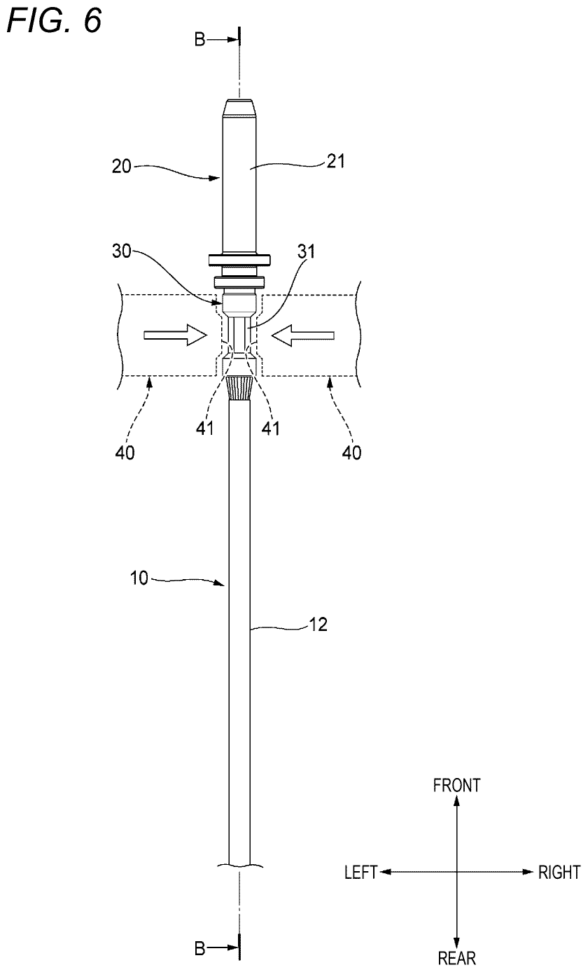

Hereinafter, a terminal-equipped electric wire 1 according to an embodiment of the present invention and a method for manufacturing the terminal-equipped electric wire 1 will be described with reference to the drawings. As illustrated in FIGS. 1 and 2, the terminal-equipped electric wire 1 includes an electric wire 10, a male terminal 20, and a tubular component 30. The terminal-equipped electric wire 1 is manufactured by crimping a contact portion 22 to a conductor core wire 11 by crimping the tubular component 30, which is disposed such that the conductor core wire 11 of the electric wire 10 is sandwiched between an outer peripheral surface of the contact portion 22 of the terminal 20 and an inner tubular surface of the tubular component 30, with a pair of molds 40 illustrated in FIG. 6. This example uses the male terminal 20, but may alternatively use a female terminal 20.

Hereinafter, for convenience of description, as illustrated in FIG. 1, a “front-rear direction”, an “upper-lower direction”, and a “left-right direction” are defined. The “front-rear direction”, the “upper-lower direction”, and the “left-right direction” are orthogonal to one another. The front-rear direction coincides with an axial direction of the terminal 20. A radial direction and a circumferential direction of the terminal 20 (contact portion 22) are simply referred to as “radial direction” and “circumferential direction”. Hereinafter, the components that are included in the terminal-equipped electric wire 1 will be first described in order.

First, the electric wire 10 will be described. As illustrated in FIG. 2, the electric wire 10 includes the rod-shaped (elongated columnar) metallic conductor core wire 11, and a cylindrical-shaped resin insulating sheath 12 that covers an outer periphery of the conductor core wire 11. The conductor core wire 11 may be formed by bundling a plurality of conductor wires or may be formed from only one elongated columnar conductor. At a distal end (front end) of the electric wire 10, the insulating sheath 12 is removed by so-called terminal processing to expose the conductor core wire 11 by a predetermined length.

Next, the terminal 20 will be described. The metallic terminal 20 is formed by casting, cutting, or the like. A hardness of a metal material constituting the terminal 20 is higher than a hardness of a metal material constituting the conductor core wire 11 of the electric wire 10. As illustrated in FIG. 2, the terminal 20 is a male terminal, and includes a connection portion 21 positioned closer to a distal end (front end) and the contact portion 22 positioned closer to a base end (rear end).

The connection portion 21 is a portion to be inserted into a base end of a female mating terminal (not illustrated) and connected to the mating terminal, and as illustrated in FIG. 2, has a solid columnar shape extending in the front-rear direction. A distal end (front end) of the connection portion 21 has a shape in which the diameter decreases as approaching the distal end (so-called tapered shape), so that the connection portion 21 can be easily inserted into the mating terminal.

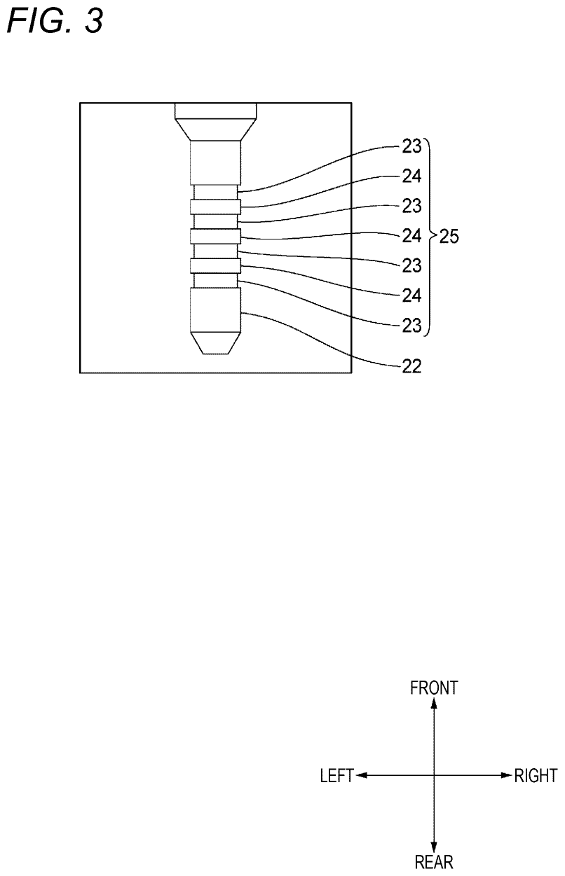

The contact portion 22 is a portion where the exposed conductor core wire 11 of the electric wire 10 is disposed to cover the outer peripheral surface of the contact portion 22 and is crimped to the conductor core wire 11, and has a solid columnar shape extending in the front-rear direction before crimping as illustrated in FIG. 2. An outer diameter of the contact portion 22 is smaller than tan outer diameter of the connection portion 21. In order to easily dispose the exposed conductor core wire 11 of the electric wire 10 so as to cover the outer peripheral surface of the contact portion 22, a base end (rear end) of the contact portion 22 has a shape in which the diameter decreases as approaching the base end (so-called tapered shape). As illustrated in FIG. 3, the outer peripheral surface of the contact portion 22 is provided with an engagement portion 25 having an uneven shape in which annular concave portions 23 and annular convex portions 24 are alternately arranged in the front-rear direction.

As illustrated in FIG. 2, a pair of front and rear flange portions 26 and 27 each extending radially outward over the entire region in the circumferential direction are provided at a boundary portion between the connection portion 21 and the contact portion 22 in the terminal 20.

Next, the tubular component 30 will be described. The metallic tubular component 30 is formed by casting, cutting, or the like. A hardness of a metal material constituting the tubular component 30 is higher than the hardness of the metal material constituting the conductor core wire 11 of the electric wire 10. The tubular component 30 has a cylindrical shape extending in the front-rear direction. The tubular component 30 has an inner tubular surface with an inner diameter allowing the conductor core wire 11 of the electric wire 10 disposed to cover the outer peripheral surface of the contact portion 22 of the terminal 20 to be sandwiched between the inner tubular surface and the outer peripheral surface of the contact portion 22. When the thickness of the conductor core wire 11 is different for each required specification of the electric wire 10, (the contact portion 22 of) the common terminal 20 is used, and the tubular component 30 having an inner tubular surface with an inner diameter corresponding to the thickness of the conductor core wire 11 of the electric wire 10 is selected and used from a plurality of types of tubular components 30 having different inner diameters. The components that are included in the terminal-equipped electric wire 1 have been described in order.

Next, a method for manufacturing the terminal-equipped electric wire 1 illustrated in FIG. 1 will be described. In order to manufacture the terminal-equipped electric wire 1, first, as illustrated in FIG. 2, the electric wire 10 in which the conductor core wire 11 is exposed at the distal end, the terminal 20, and the tubular component 30 are prepared. As the tubular component 30, a tubular component 30 having an inner tubular surface with an inner diameter allowing the conductor core wire 11 of the electric wire 10 to be sandwiched between the inner tubular surface and the outer peripheral surface of the contact portion 22 of the terminal 20 is selected and prepared from a plurality of types of tubular components 30 having different inner diameters. The electric wire 10 is inserted through the tubular component 30, and the tubular component 30 is disposed on the outer peripheral surface of the insulating sheath 12 of the electric wire 10.

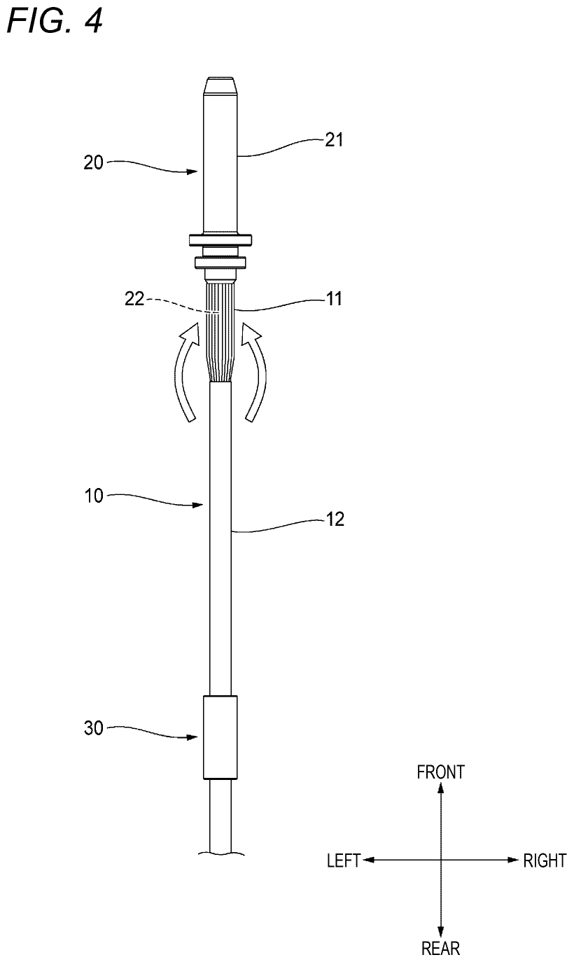

Next, as indicated by white arrows in FIG. 4, the exposed conductor core wire 11 of the electric wire 10 is disposed on the outer peripheral surface of the contact portion 22 so as to cover the outer peripheral surface of the contact portion 22 of the terminal 20. The conductor core wire 11 is preferably disposed so as to be dispersed over the entire circumferential region of the outer peripheral surface of the contact portion 22 of the terminal 20. In addition, the conductor core wire 11 is preferably disposed on the outer peripheral surface of the contact portion 22 so as to cover the engagement portion 25 over the entire region in the front-rear direction of the engagement portion 25 formed on the outer peripheral surface of the contact portion 22.

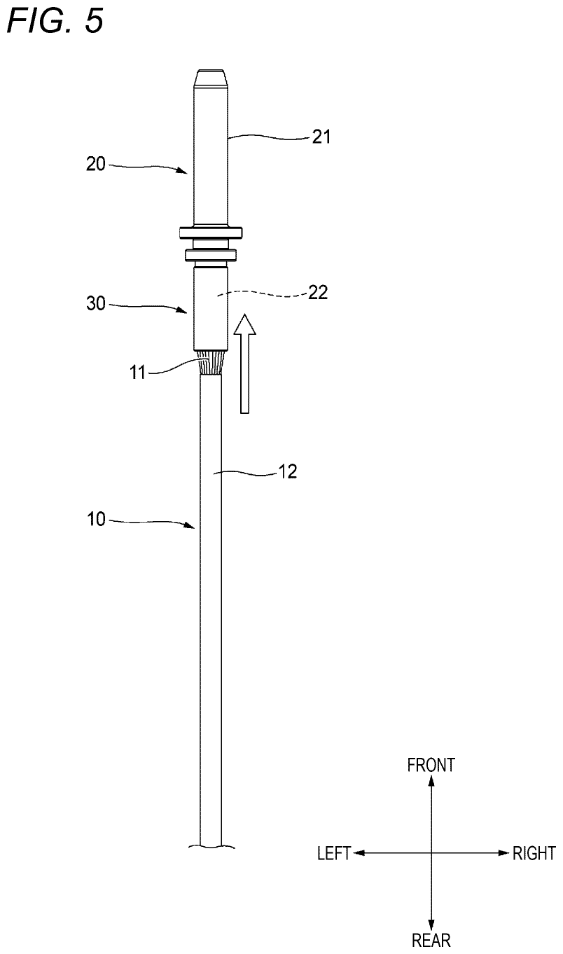

Next, as indicated by the white arrow in FIG. 5, the tubular component 30 disposed on the outer peripheral surface of the insulating sheath 12 of the electric wire 10 is relatively moved toward the distal end (front end) with respect to the electric wire 10 and is disposed at a position to cover the conductor core wire 11 of the electric wire 10 disposed on the outer peripheral surface of the contact portion 22 of the terminal 20. Accordingly, the conductor core wire 11 of the electric wire 10 is sandwiched between the outer peripheral surface of the contact portion 22 of the terminal 20 and the inner tubular surface of the tubular component 30.

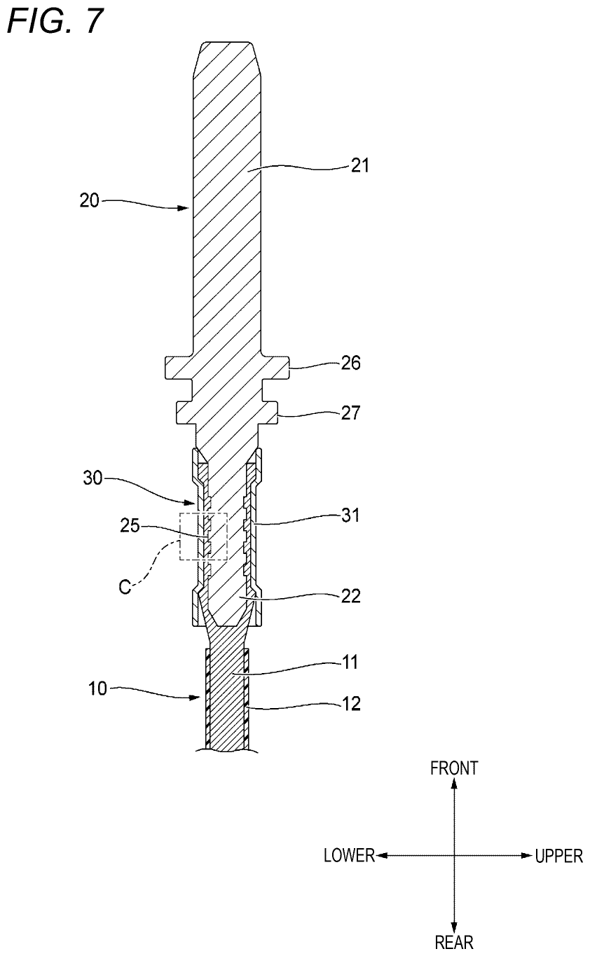

Next, as illustrated in FIG. 6, the pair of molds 40 are arranged so as to sandwich the tubular component 30 covering the conductor core wire 11 of the electric wire 10. The pair of molds 40 are implemented such that the entire crimping surfaces 41 have a hexagonal cross-sectional shape when crimping. Next, as indicated by white arrows in FIG. 6, the pair of molds 40 are brought relatively close to each other in the left-right direction, and the tubular component 30 is sandwiched in the left-right direction by the pair of molds 40, whereby the crimping surfaces 41 of the pair of molds 40 are pressed against the tubular component 30. Accordingly, the tubular component 30, the conductor core wire 11, and the contact portion 22 are integrally crimped, and the tubular component 30 presses the conductor core wire 11 toward the outer peripheral surface of the contact portion 22, whereby the contact portion 22 of the terminal 20 is crimped to the conductor core wire 11 of the electric wire 10 (also see FIG. 7).

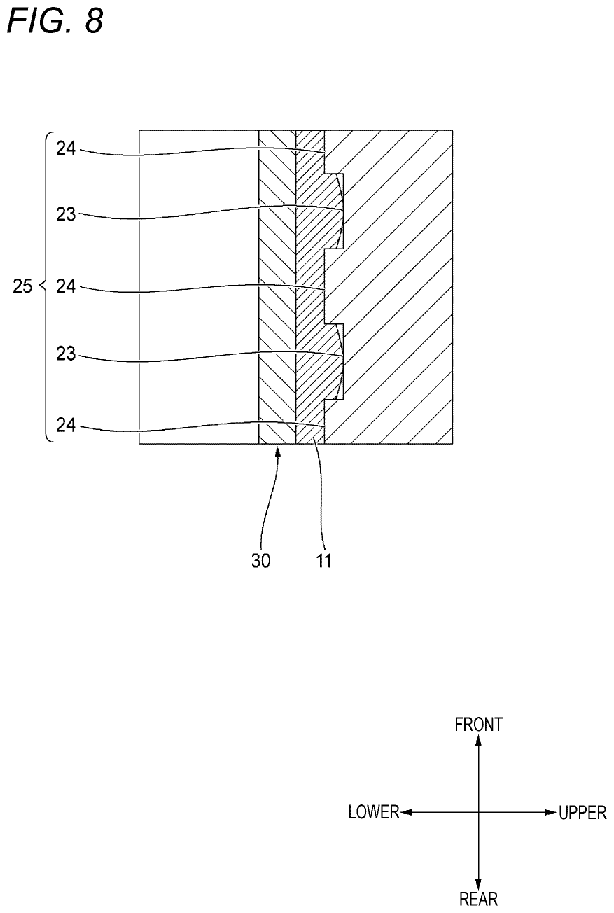

Here, since the tubular component 30 is made of metal, the tubular component 30 has sufficient strength and ductility necessary for crimping. Further, the contact portion 22 of the terminal 20 has a solid columnar shape. Therefore, during crimping, the contact portion 22 is less likely to be deformed radially inward than when the contact portion 22 is hollow, so that the conductor core wire 11 can be strongly pressed against the tubular component 30. Further, when the conductor core wire 11 is pressed against the outer peripheral surface of the contact portion 22, the conductor core wire 11 is also pressed against the engagement portion 25 formed on the outer peripheral surface of the contact portion 22. As a result, as illustrated in FIG. 8, the conductor core wire 11 is plastically deformed so as to fill the uneven shape formed by the concave portions 23 and the convex portions 24 of the engagement portion 25, so that the contact area between the contact portion 22 and the conductor core wire 11 increases. Further, the contact pressure between the contact portion 22 and the conductor core wire 11 increases particularly at a corner portion of a protruding end of the convex portion 24. Here, the plastic deformation of the conductor core wire 11 is due to the fact that the hardness of the metal material constituting the conductor core wire 11 is lower than the hardness of the metal material constituting the tubular component 30 and the hardness of the metal material constituting the terminal 20. Although the uneven shape of the engagement portion 25 may be slightly deformed as the tubular component 30 is crimped, the engagement portion 25 is not deformed to the extent that the concave portion 23 and the convex portion 24 are not distinguished from each other. As described above, as illustrated in FIG. 1, the terminal-equipped electric wire 1 in which a crimping portion 31 having a hexagonal outer peripheral shape is formed in a part of the tubular component 30 in the front-rear direction is manufactured.

### Operations and Effects

As described above, according to the terminal-equipped electric wire 1 according to the present embodiment and the manufacturing method thereof, the tubular component 30 is disposed such that the conductor core wire 11 of the electric wire 10 is sandwiched between the outer peripheral surface of the rod-shaped contact portion 22 of the terminal 20 and the inner tubular surface of the tubular component 30, and the tubular component 30 presses the conductor core wire 11 to crimp the conductor core wire 11 and the contact portion 22. That is, in the terminal-equipped electric wire 1 according to the present embodiment, unlike the related terminal-equipped electric wire, the terminal 20 and the electric wire 10 are electrically connected without providing a hollow tubular structure in the contact portion 22 of the terminal. Therefore, even if the thickness of the electric wire 10 is different for each required specification, the terminal-equipped electric wire 1 can be manufactured by using the common terminal 20 and the tubular component 30 having an inner diameter corresponding to the thickness of the electric wire 10. In general, the terminal 20 manufactured to correspond to the structure of the mating terminal or the connector housing is higher in production cost than the simple tubular component 30. Therefore, even if a plurality of types of tubular components 30 having different inner diameters are used, the overall production cost can be reduced by sharing the terminal 20. Therefore, the terminal-equipped electric wire 1 according to the present embodiment can cope with a plurality of specifications while sharing the terminal 20.

Further, according to the terminal-equipped electric wire 1 according to the present embodiment, the engagement portion 25 having an uneven shape is provided on the outer peripheral surface of the contact portion 22 of the terminal 20, and the conductor core wire 11 is pressed against and engaged with the engagement portion 25. This increases the contact area between the contact portion 22 and the conductor core wire 11, thereby improving the reliability of the electrical connection between the terminal 20 and the electric wire 10.

Further, according to the terminal-equipped electric wire 1 according to the present embodiment, the tubular component 30 is made of metal. Accordingly, for example, when the tubular component 30 is crimped to crimp the conductor core wire 11 to the contact portion 22 of the terminal 20, the tubular component 30 has sufficient strength and ductility.

Further, according to the terminal-equipped electric wire 1 according to the present embodiment, the contact portion 22 of the terminal 20 has a solid columnar shape. Accordingly, for example, when the tubular component 30 is crimped to crimp the conductor core wire 11 to the contact portion 22 of the terminal 20, the contact portion 22 is less likely to be deformed radially inward than when the contact portion 22 is hollow, and thus the conductor core wire 11 is strongly pressed against the tubular component 30. Therefore, the reliability of the electrical connection between the terminal 20 and the electric wire 10 can be improved.

### Other Embodiments

The present invention is not limited to the embodiment described above, and various modifications can be adopted within the scope of the present invention. For example, the present invention is not limited to the embodiment described above, and modifications, improvements, and the like can be appropriately made. In addition, materials, shapes, sizes, numbers, arrangement positions, and the like of the components in the above-described embodiment are freely selected and are not limited as long as the present invention can be implemented.

Here, features of the embodiment of the terminal-equipped electric wire 1 according to the present invention described above and the method for manufacturing the terminal-equipped electric wire 1 are briefly summarized and listed in [1] to [5], respectively.

### [1]

A terminal-equipped electric wire (1) including:
a terminal (20);
an electric wire (10) to be connected to the terminal (20); and
a tubular component (30) configured to cover an electrical contact between the terminal (20) and the electric wire (10), in which
the terminal (20) includes a rod-shaped contact portion (22),
the electric wire (10) includes a conductor core wire (11) to be electrically connected to the contact portion (22), and
the tubular component (30) is disposed such that the conductor core wire (11) is sandwiched between an outer peripheral surface of the contact portion (22) and an inner tubular surface of the tubular component (30), and the tubular component (30) is configured to press the conductor core wire (11) toward the outer peripheral surface of the contact portion (22) to crimp the contact portion (22) and the conductor core wire (11).

According to the terminal-equipped electric wire according to [1], the tubular component is disposed such that the conductor core wire of the electric wire is sandwiched between the outer peripheral surface of the rod-shaped contact portion of the terminal and the inner tubular surface of the tubular component, and the tubular component presses the conductor core wire to crimp the conductor core wire and the contact portion. That is, in the terminal-equipped electric wire having this configuration, unlike the related terminal-equipped electric wire, the terminal and the electric wire are electrically connected without inserting the conductor core wire into the contact portion of the terminal. Therefore, even when the thickness of the electric wire or the bundle diameter of the conductor core wire is different for each required specification, a common terminal can be used. When a tubular component having an inner diameter corresponding to the thickness or the like of the electric wire is used, the terminal-equipped electric wire can be manufactured. In general, a terminal manufactured to correspond to the structure of the mating terminal or the connector housing is higher in production cost than a simple tubular component. Therefore, even if a plurality of types of tubular components having different inner diameters are used, the overall production cost can be reduced by sharing the terminal. As described above, the terminal-equipped electric wire having this configuration can cope with a plurality of specifications while sharing the terminal.

### [2]

The terminal-equipped electric wire (1) according to [1], in which
the terminal (20) includes an engagement portion (25) having an uneven shape on the outer peripheral surface of the contact portion (22), and
the conductor core wire (11) of the electric wire (10) is pressed by the tubular component (30) to engage with the engagement portion (25).

According to the terminal-equipped electric wire according to [2], the engagement portion having an uneven shape is provided on the outer peripheral surface of the contact portion of the terminal, and the conductor core wire is pressed against and engaged with the engagement portion. This increases the contact area between the contact portion and the conductor core wire, and particularly increases the contact pressure between the contact portion and the conductor core wire at the corner portion of the protruding end of the convex portion of the engagement portion. Therefore, the reliability of the electrical connection between the terminal and the electric wire can be improved.

### [3]

The terminal-equipped electric wire (1) according to [1], in which
the tubular component (30) is made of a metal material.

According to the terminal-equipped electric wire according to [3], the tubular component is made of metal. Accordingly, for example, when the tubular component is crimped to crimp the conductor core wire to the contact portion of the terminal, the tubular component has sufficient strength and ductility.

### [4]

The terminal-equipped electric wire (1) according to [1], in which
the contact portion (22) of the terminal (20) has a solid columnar shape.

According to the terminal-equipped electric wire according to [4], the contact portion of the terminal has a solid columnar shape. Accordingly, for example, when the tubular component is crimped to crimp the conductor core wire to the contact portion of the terminal, the contact portion is less likely to be deformed radially inward than when the contact portion is hollow, and thus the conductor core wire is strongly pressed against the tubular component. Therefore, the reliability of the electrical connection between the terminal and the electric wire can be improved.

### [5]

A method for manufacturing a terminal-equipped electric wire (1) in which a terminal (20) and an electric wire (10) are electrically connected, the method including:
a step of disposing a conductor core wire (11) of the electric wire (10) so as to cover an outer peripheral surface of a rod-shaped contact portion (22) of the terminal (20);
a step of preparing a tubular component (30) having an inner tubular surface with an inner diameter allowing the conductor core wire (11) to be sandwiched between the inner tubular surface and the outer peripheral surface of the contact portion (22), and disposing the tubular component (30) so as to sandwich the conductor core wire (11) between the inner tubular inner surface and the outer peripheral surface; and
a step of crimping the contact portion (22) and the conductor core wire (11) by integrally crimping the tubular component (30), the conductor core wire (11), and the contact portion (22) using a crimping tool (40) configured to deform the tubular component (30) so as to reduce a diameter of the tubular component (30).

According to the method for manufacturing the terminal-equipped electric wire according to [5], the tubular component is disposed such that the conductor core wire of the electric wire is sandwiched between the outer peripheral surface of the rod-shaped contact portion of the terminal and the inner tubular surface of the tubular component, and the tubular component presses the conductor core wire to crimp the conductor core wire and the contact portion. That is, in the method for manufacturing the terminal-equipped electric wire having this configuration, unlike the related art, the terminal and the electric wire are electrically connected without inserting the conductor core wire into the contact portion of the terminal. Therefore, even when the thickness of the electric wire or the bundle diameter of the conductor core wire is different for each required specification, a common terminal can be used. When a tubular component having an inner diameter corresponding to the thickness or the like of the electric wire is used, the terminal-equipped electric wire can be manufactured. In general, a terminal manufactured to correspond to the structure of the mating terminal or the connector housing is higher in production cost than a simple tubular component. Therefore, even if a plurality of types of tubular components having different inner diameters are used, the overall production cost can be reduced by sharing the terminal. As described above, the method for manufacturing the terminal-equipped electric wire having this configuration can cope with a plurality of specifications while sharing the terminal.

### REFERENCE SIGNS LIST

1 terminal-equipped electric wire
10 electric wire
11 conductor core wire
20 terminal
22 contact portion
25 engagement portion
30 tubular component
40 mold (crimping tool)

What is claimed is:

1. A terminal-equipped electric wire comprising:
a terminal;
an electric wire to be connected to the terminal; and
a tubular component configured to cover an electrical contact between the terminal and the electric wire, wherein
the terminal includes a rod-shaped contact portion,
the electric wire includes a conductor core wire to be electrically connected to the contact portion, and
the tubular component is disposed such that the conductor core wire is sandwiched between an outer peripheral surface of the contact portion and an inner tubular surface of the tubular component, and the tubular component is configured to press the conductor core wire toward the outer peripheral surface of the contact portion to crimp the contact portion and the conductor core wire.

2. The terminal-equipped electric wire according to claim 1, wherein
the terminal includes an engagement portion having an uneven shape on the outer peripheral surface of the contact portion, and
the conductor core wire of the electric wire is pressed by the tubular component to engage with the engagement portion.

3. The terminal-equipped electric wire according to claim 1, wherein
the tubular component is made of a metal material.

4. The terminal-equipped electric wire according to claim 1, wherein
the contact portion of the terminal has a solid columnar shape.

5. A method for manufacturing a terminal-equipped electric wire in which a terminal and an electric wire are electrically connected, the method comprising:
a step of disposing a conductor core wire of the electric wire so as to cover an outer peripheral surface of a rod-shaped contact portion of the terminal;
a step of preparing a tubular component having an inner tubular surface with an inner diameter allowing the conductor core wire to be sandwiched between the inner tubular surface and the outer peripheral surface of the contact portion, and disposing the tubular component so as to sandwich the conductor core wire between the inner tubular inner surface and the outer peripheral surface; and
a step of crimping the contact portion and the conductor core wire by integrally crimping the tubular component, the conductor core wire, and the contact portion using a crimping tool configured to deform the tubular component so as to reduce a diameter of the tubular component.
